(19) United States
(12) Patent Application Publication
(10) Pub. No.: US 2003/0164601 A1
(43) Pub. Date: Sep. 4, 2003

(54) Porta-cell

(76) Inventor: Bob Dean Hamlett, Shawnee Mission, KS (US)

Correspondence Address: Bob D. Hamlett, 6975 Monticello Rd., Shawnee Mission, KS, 66226, US

(21) Appl. No.: 10/086,947

(22) Filed: Mar. 1, 2002

(51) Int. Cl. B62B 3/04

(52) U.S. Cl. 280/79.2

(57) ABSTRACT

A safety apparatus primarily used for prisoner cell extraction, temporary holding and transport by Military, Law enforcement and Corrections officers. The Porta-Cell apparatus is a mobile, monolithic steel unit. The occupant is secured, allowing limited freedom of movement. The apparatus is a steel rectangular unit; with a plurality of steel woven wire mesh panels, and expanded rigid panels with a frame structure of steel angle iron. The apparatus is comprised of non-corrosive materials/coatings and utilizes two (2) entry/exit doors. The side entry door positioned at the top latch position, blocks any cell escape attempts, and allows free inmate entry, eliminating physical contact. The top access door is a full length and full width entry. Entry doors utilize individual latching devices, secured by one locking device. The monolithic construction prohibits tampering and prevents any parts removal for weapons use.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING

N/A

### BACKGROUND OF THE INVENTION

### Field of the Invention

This invention relates to the safe handling of prisoners, inmates and detainees. More particularly, the present invention relates to method and apparatus of the type especially adapted for the safety of the prisoner and guard when the potential for violence and bio-hazardous contamination exist. In a further and more specific aspect, the invention concerns improvements in methods and apparatus according to prior and current technology requiring multiple guards and liability related injuries such as the aged, ill or handicapped occupants.

Various types of restraint and transport apparatus have been past and are presently used. For example, a rolling chair securing the legs, arms, ankle, and wrists with straps attached to the chair. The occupant's head is enclosed with a vented head hood to prevent biting and transmission of various virus hazards. Another method is the prisoner has shackled hands, short length, ankle chains, secured to a waist chain and marched to the designated location.

When a cell extraction is required, most correction facilities utilize the CERT, SORT, or some form of tactical team especially trained to forcefully extract and physically move a prisoner from his or her cell to another location. Each team member is fully enclosed in protective battle gear and uses a variety of specialty weapons such as tear gas or electronic stun shock. The current procedure is to physically overwhelm the prisoner often resulting in injury, death and/or liability suits. The above listed methods require multiple manpower relating to prisoners, and exposing all parties to injury, and exposure from contaminated blood, body fluids and contagious virus.

Especially common are the corrections inmates that routinely visit the prison infirmary or off site hospitals exposing the medical staff and others to said hazards. To insure the safety, several guards are usually required to escort each inmate to off-site hospitals or other locations at great taxpayer expense. Dealing with prison violence and sexual disease is a daily practice, and occurs at a rate of twenty times greater than the general public. In an preferable system it is generally desired that the guards, prisoners and general public sustain no injuries and receive benevolent humane protection from dangers, to include airborne viruses, blood related viruses and contagious disease's such as HIV, AIDS, Hepatitis or the like.

Police and corrections officers researched, complain that prisoner cell removal and transport remains their most dangerous duty, and further, that prisoners, inmates, and suspects are most likely to become violent at the moment when handcuffs or shackles are placed on them.

It would be highly advantageous, therefore, to remedy the foregoing and other deficiencies inherent in the prior art. Most evident of the multi-functional, Porta-Cell apparatus is prison cell extraction. It provides the occupant freedom of hand, leg and body movement in a safe, confined compartment reducing anxiety and anger, also eliminating/limiting injury to himself and the attending guard. In extreme conditions, handcuffs are an additional option for the attending guard to determine. During cell extraction, the side entry door (upward sliding entry/exit door) is raised and latched. It filly blocks any escape from the prisoner cell area. Both ends of apparatus are equipped with adjustable chains and cinched to the existing cell bars, thus rendering the apparatus unmovable by the inmate during and after the opening of his/her cell door.

Consequently the only exit opportunity is for the occupant to enter the apparatus. The up/down vertical sliding door is then closed to the down position, then latched and locked. Human body contact is avoided. Further, when the occupant enters the infirmary, the sliding door can be placed in the lowest of three positions, which is seven inches higher than the floor of the apparatus, allowing a safe area for the doctor to administer medication, food, water or injections. Bedpan services can be rendered while the inmate is securely contained in the apparatus. Also, the top full-length door may be fully open with the occupant remaining in a non-threatening position at the discretion of the attending medical staff. Said door is utilized for other entry options, such as when forced entry is necessary. Accordingly, it is an object of the present invention to provide improvements in areas such as personal health care, safety, and lower taxpayer health care expenditures, reduced manpower related expenses, litigation, and improving the morale of the staff and their families.

Further described objects of the invention includes provisions of improvements that is especially adapted for multiple functions that can be utilized with various government agencies such as Corrections, Police, Border Patrol, Military Detainees, Airports, CIA, FBI, Hospitals etc.

Still another object of the invention is the provision of improved means whereby the two door locking mechanisms are secured by one standard handcuff type lock in which all officers possess, and any of them can readily access the proper keys in an emergency.

Another object of the invention is the solid one-piece seat. The angle and construction allows a measure of comfort, while discouraging a combative mode. The reclined and curved steel seat design allows the occupant to remain un-shackled in a semi-prone non-combative position. When flinging arms or legs are in motion, the occupant's gravity fulcrum slides downward to a defenseless position. The seat and floor design prohibits water, moisture, and urine retainage inside the apparatus and provides maintenance free, ease of cleaning.

Another object of the invention, allows a manual hand brake device to be applied and locked when the steering handle is pulled toward the operator. The brakes are smoothly applied and the parking lock device can be pivoted downward ninety degrees to be used as the parking brake and/or brake lock. The cuff lock can then be placed through the brake lock loop device.

Another object of the invention, is the two separate panels of shatter resistant Polycarbonate installed at the top and at the rear control area of the invention. The tinted/transparent plastic, provides a measure of head and upper body protection to the occupant in adverse weather conditions, which also provides a safe area for the attending guard and provides his/her protection from body fluids such as saliva, urine, blood and other bio-hazardous projections.

Yet another feature of the apparatus construction is the fabrication materials. When secured, there are no removable parts that can be used as weapons. The all steel components are of stainless steel, aluminum or carbon steel coated with powder coating or equal, preventing deterioration and allowing rugged durability with ease of cleaning. The narrow compact dimensions allow easy entry through the more modern prison doors, showers and remote building structures. The design with multiple lift handles also allows easy loading onto trucks, van vehicles and aircraft for remote transporting purposes.

Yet another additional feature is the black vinyl cover that is form fitted to the apparatus when privacy is desired. Said cover fully encloses the apparatus with the exception of the bottom seven inches from the floor of the apparatus to allow for sufficient air ventilation and observation opportunities for the attending guard. A rear-hinged access door behind the seat, allows for the storage of the cover when not in use. The storage compartment also allows space for the occupant's personal files and personal items when in transit. The compartment provides hands free operation for the attending officer or guards.

PRIOR ART

| | | | |
|---|---|---|---|
| 4159141 | June 1979 | Dirck | 296/24. |
| 4470228 | September 1984 | Dirck | 296/24. |
| 4641387 | February 1987 | Bondy | 5/658. |
| 5044025 | September 1991 | Hunsinger | 5/424. |
| 5080416 | January 1992 | Dirck | 296/24. |
| 5384925 | January 1995 | Vail | 5/424. |
| 5678874 | October 1997 | Choate | 296/24. |
| 5765842 | June 1998 | Phaneuf | 280/47. |
| 5848817 | December 1998 | Niehaus | 296/24. |
| 5961133 | October 1999 | Perry | 280/33. |
| 6041894 | March 2000 | Otterson | 188/19. |
| 6237725 | May 2001 | Otterson | 188/19. |

### BRIEF SUMMARY OF THE INVENTION

The object of the present invention relates primarily to cell extraction and ease of occupant transport. The inventor's intention is to provide a safe environment for corrections officers, Inmates, prisoners and detainees. The compact apparatus allows limited freedom of movement for the occupant while contained in a secure environment, further, allowing a maximum safety margin for the attending guards. The occupant may be violent, ill, aged or physically disabled requiring specialty alternatives. The apparatus is a one-piece, horizontal monolithic unit comprised of pressed steel and woven mesh panels welded inside, and to the steel angle iron support frame structure. Two (top and rear) protective shields of polycarbonate shatterproof plastic panels protect the guard steering control area. The occupant compartment size is constructed of life-size dimensions.

The mobile apparatus is mounted on four wheels in which the foot end wheels (2) are 360 degrees swivel, incorporated with an additional foot parking brake system. The two headboard wheel brakes are activated by a reverse direction from the steering control handle, used in conjunction with the adjacent drop-down parking latch and locking loop device. The apparatus comprising two separate entry/exit doors. A simple verticle lifting motion operates the side entry, with three latching positions available allowing the opportunity of free entry of a questionable inmate with possible violent intent. The top full length, fill width door is hinged to completely open 270 degrees from the closed position allowing a forced entry when necessary.

Said top hinged door comprises the upper enclosure frame. The control end of the horizontal rotating rod provides for the said door operating handle. The one-piece horizontal control rod is incased by larger cylindrical sleeves, which is welded in place to the upper doorframe The four top door rotating door latch pins are incorporated onto the rotating horizontal axis rod (Between the multiple sleeves) to prevent the rod and door control handle removal, and provides the latching mechanism whereas both doors can be simultaneously locked with a single standard handcuff or the like.

### BRIEF DESCRIPTIONS OF THE SEVERAL VIEWS OF THE DRAWINGS

FIG. 1 is a large perspective elevation view of the Porta-Cell in accordance with the present invention.

FIG. 2 is an enlarged and fragmentary side elevation view of the top door lid and frame, and side lift door and frame, exposing the lower door latch, upper door latches, continuous latch control rod, and the single combination locking device securing both entry doors.

FIG. 3 is an expanded fragmentary view similar to FIG. 2, showing the officer operating control area, control steering handle, doors, door latches, door locks, brake lock, protective shields, cinch, and frame structure.

FIG. 4 is an enlarged and fragmentary cross-sectional view of one of the four top door latching pins with the upper view displaying the coordination of design placement, rotating lift handle, the extending rod, cylindrical rod housing sleeves.

FIG. 5 is a side elevation, fragmentary view of the parking brake and rotating parking lock device. Further showing the lower steering handle support and guide similar to FIG. 6.

FIG. 6 is a enlarged fragmentary plan view of one of the two stationary handle guides.

FIG. 7 is an enlarged, fragmentary elevation view of the side door, spring activated side door latching device, a partial view of the vertical direction side door frame, the single upper locking mechanism that coordinates alignment that secures both doors with handcuffs or standard locks.

FIG. 8 is a perspective top plan view of the bottom steel frame construction.

FIG. 9 is a perspective top plan view of the top steel frame construction.

FIG. 10 is a perspective top plan view of the top steel door entrance frame construction.

FIG. 11 is a partial elevation view (wheels not in view) of the headboard end frame and woven mesh panels, storage compartment, and polycarbonate protective shield.

FIG. 12 is a partial elevation view of the foot end frame construction with the auxiliary stationary lift control bar, and the compressed steel sheeting panels.

FIG. 13 is an enlarged fragmentary view of the top entry door rotating latch pin device. (Qty 4)

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structure and functional details disclosed herein are not to be interpreted as limiting, but merely as a basis for the claims and as a representative basis for teaching one skilled in the art to variously employ the present invention in virtually any appropriately detailed apparatus.

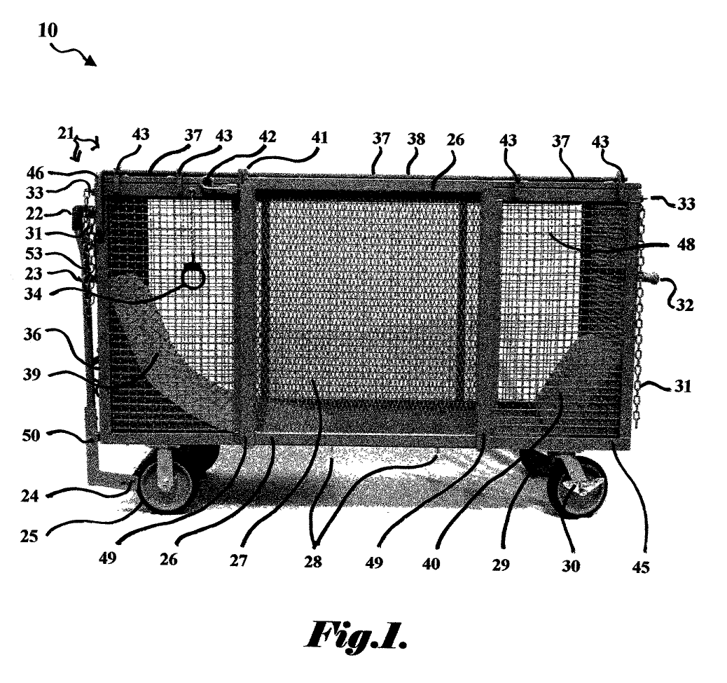

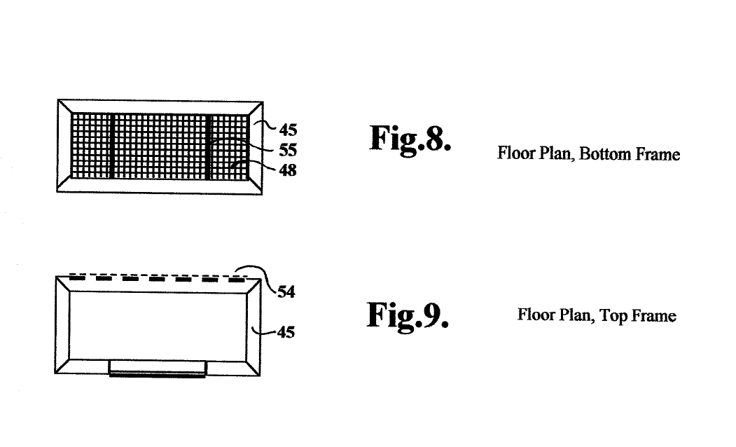

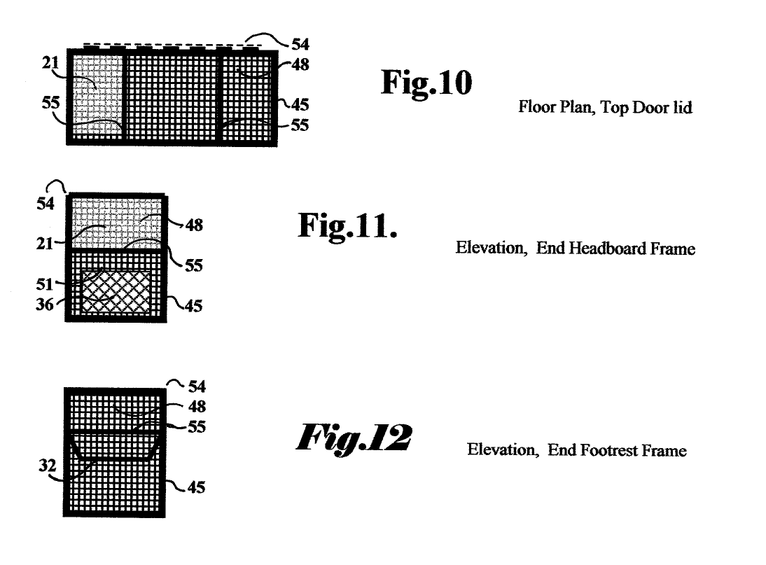

The apparatus comprises of a mobile, one piece all-steel rectangular shaped unit, that is enclosed with a plurality of steel woven wire mesh, and expanded rigid steel wall construction. The reference arrowed numeral 10 generally designates the apparatus in accordance with the present invention that is adapted for cell extraction, prisoner care, and transport or the like, such as that also shown in perspective as FIG. 1. The apparatus compartment enclosure comprises a lower steel frame, FIG. 8, an upper partial steel frame, FIG. 9, and an additional upper steel frame comprising the top hinged entry door, FIG. 10.

Compressed rigid steel panels 48 and woven wire mesh panels are securely welded inside the vertical and horizontal angle iron frame sections to discourage escape attempts and abuse. Said mesh panels are reinforced with vertical and horizontal steel angle or steel strap material at periodic intervals to strengthen any vulnerable areas as shown 55 in FIG. 8. Said panels are to be included at all six surface areas, the top, bottom, both side elevations, headboard and foot end locations to ensure security and clear officer observation. Heavy duty, rigid compressed steel panels are utilized at areas of unusual high stress such as the foot end, head end, elevation, floor area, vertical sliding door panel, and top of the upper entry door.

The side vertical sliding door opening 26 & 27 is completely unobstructed by the upper frame as shown in FIG. 9., and when the side and top doors are in the full open position, the sliding door can be removed allowing free walk-in access to the occupant compartment. This function will facilitate easy entry involving other areas of use, for example an elderly prisoner, or an injured officer requiring safe evacuation from riot or war conditions.

The opposite longitudal side elevation comprises of a one-piece continuous, woven wire mesh panel that in one application, the exterior is 65 inches long×31 inches in height (without the four wheels) welded securely inside the framed angle. The said occupant compartment has substantially life size dimensions and is constructed of materials suitable for sanitary, exterior and interior use. In one application the occupant interior compartment has a length of 66 inches in length and 25 inches in width.

The apparatus materials are of stainless steel, and/or other weather proof, rustproof materials or the like. In one application, all the finished materials were of carbon steel completely coated with machine gray powder coating treatment.

The vertical sliding door entry 26 & 27 is fabricated with rigid steel box frame tubing 26. The corresponding expanded metal panel 27 is rigidly secured, same as the other insert panels, by welding from the interior side of said doorframe. The vertical movement of said door, slides inside a steel channel jamb 49, comprised of angle iron and welded flat plate steel to form the channel guide FIG. 7.

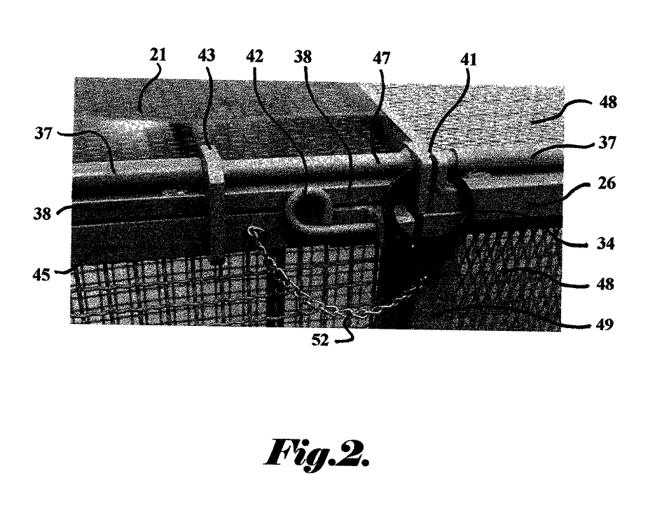

The upward sliding side door is removable when in the unlocked, unlatched position, providing protective, convenient, emergency personnel evacuation or using as equipment storage. The said doorframe 26, FIG. 7. has three holes drilled/placed into the vertical edge of the jamb called receiver holes to receive the spring loaded latching pin 42 detailed in FIG. 2. and FIG. 7. Said receiver holes, provide multiple door settings for—closed, seven inches open, open fully,—or door fully removed. By raising the side entry door 27—FIG. 1. to the top latch position FIG. 7., (Three positions available) blocks any cell escape attempts and allows free inmate entry. (All physical contact is avoided) This same side door elevation plan FIG. 1. also shows the two adjustable cinch chains 31 located at the right and left topside corners that are sufficiently welded to the upper frame. The two cinch 33 FIG. 3. operated chains 31 provide temporary securement of the apparatus to a variety of existing cell bars during occupant entry and exit, thus blocking all escape avenues. The design affords a safe one-officer operation, when confronting inmates/detainees with unpredictable behavior patterns.

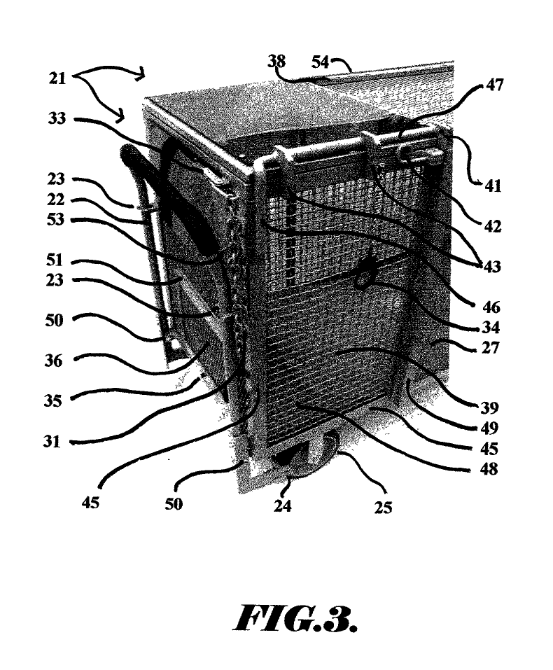

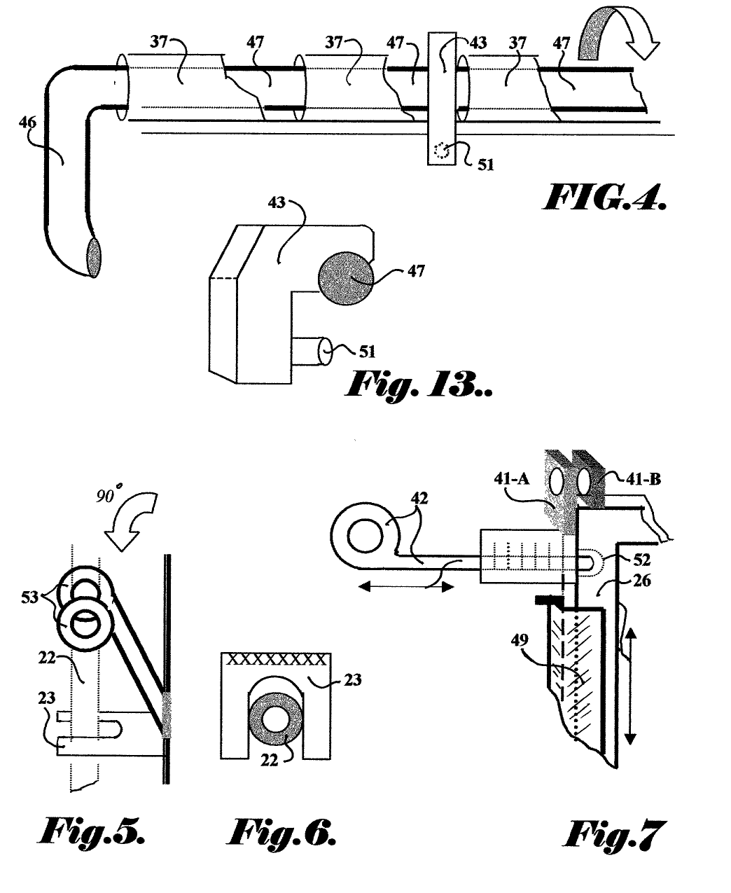

An additional 12 inch guidance and lift bar is welded at the front end of the unit allowing additional officer lifting points and also allowing multiple inmates to be externally shackled in the same location. Further reading of the text will explain the benefits of said sliding door openings. Both entry doors have individual latching devices, however one locking mechanism secures both doors in the lock position. The double door locking mechanism is 41A and 41B, on FIG. 4. aligns in conjunction to facilitate the locking of both top and bottom doors with one standard handcuff or any standard lock of preference.

To form the occupant seat 39, a one-piece sheet of heavy duty sheet metal, or equal, is formed to ¼ circle or less cylindrical, smooth surface shape to maintain the gravity design and position of the occupant, so as to discourage combative actions with the arms, legs and feet. The seat is fabricated to form fit the interior compartment walls as to discourage finger or hand placement upon occupant exit. The seat mount consists of two sliding adjustment bolts 28, secured with two locking nuts located at the bottom exterior of the lower frame. In one application, the seat is stationary and welded securely in place with no adjustments.

Two side metal panels of the seat, are welded to fit the side contours of the seat leaving the void space behind the occupant detailed in FIG. 3 and in FIG. 1., as the rear cover and personnel files storage compartment 36 shown in FIG. 3. and FIG. 11. Said storage area is only accessible from the exterior access door 36. The form-fit black vinyl apparatus cover (not shown) allows privacy when desired. The said cover exposes the bottom 7 inches or less above the floor area for occupant ventilation and officer observation purposes. The said vinyl cover is stowed in the provided rear storage compartment 36 that also serves for inmate items and personnel files. A gravity latch 35 secures said door.

Laterally opposite of the seat is the occupant footrest 40. FIG. 1. A welded one-piece triangular steel enclosure that includes five surfaces snugly fit the occupant compartment foot space. The footrest 40 welded in place, provides the occupant balance, and a measure of bracing comfort. The footrest position most importantly discourages and reduces kicking damage to the foot end metal panel.

The top entry door lid 38, as shown in FIG. 2. and FIG. 3. Incorporates a frame of steel box tubing fitted to coincide with the outside dimensions of the said compartment frame, with a full length rigid expanded metal panel 48 comprising the insert panel. Two box tubing, cross member steel reinforcement are strategically placed for structure integrity. Operation of said top door is multi-functional. One feature is a sheet of polycarbonate shatterproof shield material 21, FIG. 2 and FIG. 1. is transparent and color tinted, mounted above the woven mesh insert. Said shield provides a measure of safety and weather protection for the upper areas of the occupant and also provides a safe area of operation for the attending officer from any occupant projections such as biohazards produced from infectious disease.

The headboard end of the apparatus also utilizes a second, additional protective shield 21 for the back area of the occupant as shown in FIG. 3. and FIG. 11. Said top door entry, also incorporates a horizontal heavy-duty 34 solid steel rod assembly 47, FIG. 2. FIG. 3. and FIG. 4., that also comprises a door lift handle 46, FIG. 3 and FIG. 4. Also a double latch/lock mechanisms 41A and 41B detailed in FIG. 2 and FIG. 7. which serves as one and the same locking device using standard handcuff or similar locking devices. In one application, one standard law enforcement hand cuff 34—FIG 1. of the smith and Wesson variety, is secured to a restraint chain, 31 then welded securely to the apparatus frame. Note: the second cuff 34 is similarly attached to the headboard frame, to secure the parking brake 53—FIG. 5.

The said door operating handle 46 and corresponding rod 47, can extend the full length of the apparatus. Three cylindrical sleeves of variety length, 37 shown in FIG. 2 are of a larger inside diameter that incases the control rod 47. The door latching pin units (Qty Four) 43 are tooled and welded securely to the horizontal rod 47. shown on FIG. 2, FIG. 3, FIG. 4. The said pipe sleeves are then properly spaced and welded onto the top doorframe 38 shown in FIG. 2. and FIG. 4. Said Cylindrical pin 51 is inserted into the corresponding holes in the frame.

This rigid construction prohibits tampering and removal of any parts to be possibly used as weapons. Said fabrication procedure also allows the freedom of the control rod movement and handle axis rotation, allowing the fully hinged door 54 FIG. 9. to be manually opened by the handle 46 permitting said door 38 to be opened to a 270 degree full open position.

The officer/operator control handle 22—FIG. 3. and braking system 24 works as one and the same. A downward motion will activate the smooth spring loaded braking bar system 24. A swing down steel hinged gravity latch 53—FIG. 5., will place the brakes in a park position. A similar attached handcuff locking mechanism 34 will lock the rear brake utilizing the double steel oval loop device. 53—FIG. 5, placing the brake—steering controls into a tamper proof mode.

The wheel braking system 24 is a smaller cross lateral solid rod inside a larger pipe sleeve inserted with a retracting spring stop 24 to eliminate constant drag function on the wheels when brake pressure is not applied. The said control handle 22 operates the brake on two pivot points 50 secured to the bottom frame shown in FIG. 3. Reverse direction, control handle 22 movement by the operator applies the parking brake 24. The parking brake device FIG. 5. is activated by a downward rotation of the 90-degree latch and lock mechanism 53, securing the control rod 22 in the reverse pressure brake position. Locking the brake in place is then accomplished by placing a standard handcuff or a standard locking device through the enlarged oval double steel loops 53. also shown on FIG. 5.

Metal fatigue/stress of the steering control rod 22 is reduced, and steering control is aided by another new improvement. Two steering rod guides.23. FIG. 3. FIG. 5 and FIG. 6.

Looking to the opposite foot end elevation FIG. 12.) shows the end frame with an expanded compressed steel panel insert, 48 reinforced with a steel cross member support, 55 and an auxiliary loading and control lift handle 32—FIG. 1 and FIG. 12. The said apparatus affords a one officer operation, however this additional 12 inch guidance and lift bar 32—FIG. 1. is welded on the cross brace support 55 located at the footboard end of the unit. The said handle serves to allow additional officers lifting leverage when loading, maneuvering over rough terrain or stairs and also allowing multiple inmates to be externally shackled (handcuffed) to the apparatus, secured at the same location in emergencies such as street or prison riots.

Four, 8 inch diameter wheels 25 shown in FIG. 1. are of Jarvis Poly-Loc type or equivalent, with weight and bearing capacity of 1000 lbs per each wheel. On one application, foot operated auxiliary brakes 30 are provided for the two foot end swiveled wheels. The two headboard wheels 25 are non-swivel and (welded in place) stationary.

It is to be understood that while certain forms of the present invention have been illustrated and described herein, it is not to be limited to the specific forms or arrangement of parts described and shown. Black and white photographs in conjunction with detail drawings better serve to illustrate the intricate lines and graphics in a manner much more legible to the viewer than the conventional drawings could accurately depict.

What is claimed and desired to be secured by letters of patent is as follows:

1. A mobile, security apparatus, for prison cell extraction, temporary holding cell, transporting, and trundle of prisoners comprising:
(a) an enclosed rectangular occupant compartment of life-sized dimensions adapted for exterior and interior use.
(b) a plurality of woven wire mesh panels, compressed steel panels, a contour seat, and attached steel structured frame mounted on wheels, including a side and top entry/exit doors to contain, hold or transport the occupant in relative safety and comfort.
(c) attachment means having second structure means such that said attachment means is secured both to said compartment and to adapting hardware such that said attachment means are capable of withstanding abusive forces.

2. The Porta-Cell apparatus in accordance with claim 1. including a non-removable, monolithic, horizontal rotating control bar with multiple attached gravity latching devices. Each supporting an attached cylindrical insert pin with the receiver mechanism incorporated into the horizontal top steel frame section. Said bar has attached, a combination, dual action, locking receiver that in conjunction with adjacent receiver, secures the side and top door with a single handcuff or standard locking device. Said bar is shrouded with multiple cylindrical steel sleeves (separated by the latches) and securely attached to the top doorframe. Said bar incorporates and comprises the top door lift control handle.

3. The Porta-Cell apparatus in accordance with claim 1.including,
(a) attached cinch (2) and corresponding adjustable chains (2) located at both end locations of the apparatus for temporarily securing the apparatus to typical prison cell bars for the prevention of prisoner escape attempts during occupant entry into the apparatus through the open, vertical sliding side door.
(b) a vertical sliding entry/exit door housed by vertical angle iron and flat steel secured guide channels. A supporting a spring loaded, retractable latching device attached to the said door jamb. The latch pin is laterally inserted into the vertical sliding door jamb at multiple positions/locations, providing for minimal openings for safe containment, and providing for the occupant's needs, non exclusive to, medical care and nourishment
(c) an attached side door lock receiver that aligns with the duel function top door frame lock receiver, Said doors in the latched and lock position permits securement of the apparatus utilizing a single handcuff or standard locking devices.

4. The Porta-Cell apparatus in accordance with claim 1.including,
(a) a contour, one-piece, simi-reclining metal occupant seat with the purpose of reducing combative behavior. Said seat device discourages abrupt upward movement of the arms and legs to maintain equilibrium. Said seat is form fitted to the confined area allowing the occupant limited freedom of movement void of shackles or restraints.
(b) a steel, five surface-sided corresponding footrest attached at the compartment foot end, horizontally opposite to the seat, provides the occupant balance and stability. Said footrest is multi-functional as the construction design and dimensions prohibit kicking abuse directed at the foot end; exterior compressed expanded metal insert panel.
